(19) United States
(12) Patent Application Publication
(10) Pub. No.: US 2025/0074359 A1
(43) Pub. Date: Mar. 6, 2025

(54) LOW-VOLTAGE SENSOR SECURITY SYSTEM FOR CATALYTIC CONVERTER THEFT PREVENTION

(71) Applicant: Jeziel Jones, Aubrey, TX (US)

(72) Inventor: Jeziel Jones, Aubrey, TX (US)

(21) Appl. No.: 18/456,506

(22) Filed: Aug. 27, 2023

(51) Int. Cl. B60R 25/30; B60R 16/023; B60R 25/10; B60R 25/40; G06T 7/70

(52) U.S. Cl. CPC B60R 25/305; B60R 16/0233; B60R 25/1004; B60R 25/403; G06T 7/70; B60R 2300/103; B60R 2300/8073; B60R 2325/106; G06T 2207/10048; G06T 2207/30196; G06T 2207/30252

(57) ABSTRACT

The present invention describes a system comprised of sensors, microcontrollers, wireless communication modules, and methods for utilizing said sensor system to determine, in real-time, a threat and/or theft of a catalytic converter. An alarm signal is then generated by connecting with the security system of a premises, if available, and relevant parties and law enforcement are notified of the threat and/or theft event.

### CROSS-REFERENCE TO RELATED APPLICATIONS

The present application claims priority to U.S. provisional patent application Ser. No. 63/373,706 filed on Aug. 27, 2022. The entire disclosure is included herein in its entirety at least by reference.

### FIELD OF THE INVENTION

The present invention is in the field of security systems and vehicle alarm systems.

### BACKGROUND OF THE INVENTION

Due to the rise of precious metals over the past few years, there has been a marked increase in the thefts of catalytic converters. Catalytic converters are part of the exhaust system that remove harmful pollutants from engine emissions. The catalytic process is supported by honeycomb catalyst structures coated with precious metals that are most commonly platinum, rhodium, and palladium. Catalytic converters contain multiple grams of these metals that can be extracted and sold.

The most common method to stealing a catalytic converter involves using a reciprocating saw, also known as a sawzall, to sever the exhaust pipe before and after a catalytic converter, “pre-cat” and “post-cat”, respectively. In addition to the engine and fuel performance a vehicle lacking a catalytic converter can suffer, catalytic converters are expensive to replace and can be cost prohibitive for many vehicle owners, even they possess car insurance. Further, owners with vehicles lacking the catalytic converter component are inconvenienced by the inability, in some states in the US, to pass emissions inspections. Beyond the time and financial inconvenience, this can negatively impact business operations in the case of vehicle owners with work vehicles that need to be taken off of the road for catalytic converter repairs or replacement.

Most known approaches involve structural changes, such as steel cages, to a vehicle in order to secure the catalytic converter(s) of a vehicle. With expensive, lengthy installs, in the case of the solutions such as installed steel cages or steel ropes around catalytic converters, many vehicle owners forego this installing such a form of theft prevent. Thieves still are able to sever through such catalytic converter theft prevention arrangements.

Further, current approaches on the market don't integrate with a premises alarm system and there are many advantages to integrating with the alarm security of the premise, including, but not limited to: being able to “arm” the device such that intrusions are reported via the security system, receive real-time alerts, and transmit an alarm signal to relevant parties including vehicle owners, central monitoring services, and police departments.

Therefore, what is needed is a system that employs the use of an array of sensors to determine a threat, theft attempt, or theft of a catalytic converter in real-time and alert relevant parties-including security alarm systems, vehicle owners, central monitoring services, and police departments.

### SUMMARY OF THE INVENTION

The present invention describes a system comprised of sensors, microcontrollers, wireless communication modules, and methods for utilizing said sensor system to determine, in real-time, a threat and/or theft of a catalytic converter. An alarm signal is then generated by connecting with the security system of a premises, if available, and relevant parties and law enforcement are notified of the threat and/or theft event.

Accordingly, in an embodiment of the present invention, a theft prevention security system for one or many catalytic converters is provided comprising:
a plurality of sensors strategically placed on, or nearby, the catalytic converter of which record sound, vibration, motion, and image data and send these signals and data as input to a microcontroller located proximally (within millimeters) to the sensors, mounted on or located within the addressed vehicle;
the microcontroller which provides power to the sensors and reads the output signals and data from the sensors to algorithmically determine a positive a threat and/or theft;
an alarm system interfacing method consisting of various arrangement options, one arrangement of which described herein is an electromagnet located proximally to a wireless door sensor when in combination, connect to the security system of a premise-residential, commercial, or otherwise—and provide the ability to programmatically trigger an intrusion event by modulating the voltage supplied the electromagnet from a microcontroller; and
a wireless communication module to provide the capability of sending signals and data from the invention described herein to other networked devices and to the cloud.

One aspect of the present invention is to provide a sensor security system for one or many catalytic converters. The system incorporates an array of sensors including, but no limited to: vibration sensors, with spring-vibration and/or ball tilt switch sensors permanently or semi-permanently to detect suspicious motion near the catalytic converter; a gyroscope and 3-axis accelerometer module to detect suspicious motion; a camera module capable of low-light imaging and flash-capabilities for night-time monitoring, to provide image input data for detection of objects and/or persons that pose as threats; an omnidirectional microphone module for detection of sounds such as power tools, sawing, metallic grinding, and similar noises present during the theft of catalytic converters.

Another aspect of the system is a microcontroller that controls power to the sensor array, receives input signals and data from the sensors, and connects to any available alarm systems of a premise for triggering an alarm if a threat to the catalytic converter is detected. The microcontroller also has a wireless communication module to provide the capability of sending signals and data from the invention described herein to other networked devices and to the cloud.

A further aspect of the present invention is a method of interfacing with the alarm systems of any premise by using wireless door contact sensors paired to a premise's alarm system. By way of an electromagnet connected to the microcontroller, a wireless door contact sensor can be triggered by modulating the voltage supplied to the electromagnet from the microcontroller. A door contact sensor, when paired to an alarm system, will trigger an alarm by way of the presence of or removal of a magnetic field, depending on the kind of door contact circuit. It is in this way that a wireless door contact sensor will be induced by an electromagnet to trigger an alarm in the event of a theft event to a catalytic converter. It can be conceived that a door contact sensor is not the only wireless alarm sensor that can be utilized as an interface to the sensor security system described herein.

### BRIEF DESCRIPTION OF THE DRAWINGS

FIG. 1 is a top view of a vehicle incorporating one embodiment of the sensor security system for catalytic converter theft prevention. This figure also shows the alternate placements of Module 30 that can exist based on where power is drawn from the vehicle.

FIG. 2 is an enlarged side view of the catalytic converter and a location where Module 20, containing the vibration detection sensors, can be placed on the input pipe, “pre-cat”, of the catalytic converter.

FIG. 3 is an enlarged side view of the catalytic converter and a location where Module 20, containing the vibration detection sensors, can be placed on the output pipe, “post-cat”, of the catalytic converter.

FIG. 4 is an enlarged front view of Module 20, containing the vibration detection sensors, that is placed around the input and/or output pipe of the catalytic converter

FIG. 5 is a block diagram of the arrangement of Module 30, which: provides power to the system; contains a wireless communication module to provide the capability of sending signals and data from the invention described herein to other networked devices and to the cloud; and a method for interfacing with an alarm system by means of an electromagnet located proximally to a door contact sensor.

FIG. 6 is a block diagram of the arrangement of Module 40, which contains a camera, microphone, accelerometer, and gyroscope sensors, LED lights for illumination, a microprocessor for analyzing the input signals and data from the aforementioned sensors, and a wireless communication module for sending data from the sensors to other networked devices and to the cloud.

### DETAILED DESCRIPTION OF THE DRAWINGS

In the following description, reference is made to the accompanying drawings, which form a part hereof. The illustrative embodiments are not meant to be limiting. Other embodiments may be utilized, and other changes may be made, without departing from the spirit or scope of the subject matter presented here.

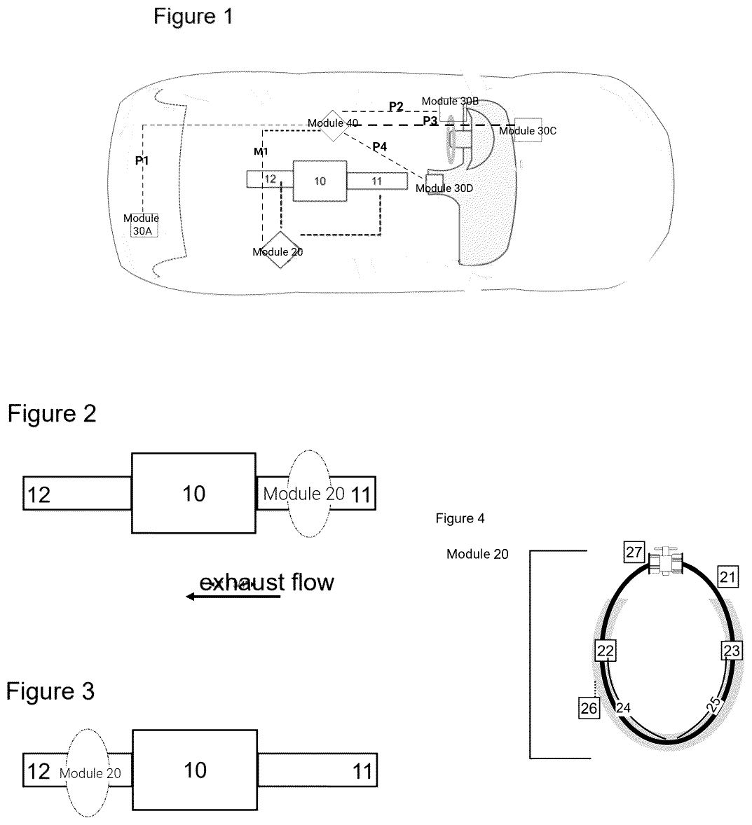

Referring to FIG. 1, a sensor security system for catalytic converter theft prevention is shown comprising of Module 20, Module 30, and Module 40 in a proposed mounting configuration on a vehicle from a top/birds eye view. The catalytic converter 10 is shown, though different vehicles will have more than one catalytic converter and it can be located in different positions depending on the vehicle. Module 40 is mounted under the vehicle, on the vehicle chassis or an otherwise secure mounting position proximal to the catalytic converter 10. Module 20 is mounted under the vehicle on the input pipes, “pre-cat”, or output pipes, “post-cat”, of the catalytic converter. Module 20 contains the vibration sensors and as such must be located proximal to the catalytic converter to detect vibrations from sawzalls, the tool commonly used to steal catalytic converters. Module 30 is responsible for providing power to the system described herein, and as such is located near sources of power located in a vehicle, namely near fuseboxes, batteries, and auxiliary power outlets. These sources of power are depicted by the boxes 30A-D. 30A and 30C denote a power source from a vehicle battery and/or fusebox, as these power sources are located within the engine compartment or the trunk depending on the vehicle. 30B depicts a power source from a fusebox which is inside the vehicle, typically located under the dash near the steering wheel, though different vehicles have different locations of interior cab fuse boxes. 30D depicts a power source from a vehicle's auxiliary power outlet, typically located in the dashboard or center console, though different vehicles have different locations and qualities of auxiliary power outlets. Referring to FIG. 1, dashed lines P1-P4 demonstrate the various ways in which Module 30 connects to Module 40, depending on the various aforementioned location chose to install Module 30. This connection is a wired connection over insulated copper wires which run from Module 30, located within the vehicle, trunk, or engine compartment, to Module 40, located underneath the vehicle and mounted to the vehicle chassis. The wired connection is run in a manner that is most optimal for secure mounting without invasive cosmetic or structural changes to the vehicle. Referring to FIG. 1, Module 40 is mounted under the vehicle, within a waterproof, heat-resistant, and chemical resistant enclosure, on the vehicle chassis or an otherwise secure mounting position proximal to the catalytic converter 10. Module 40 is an arrangement of sensors used to detect threat events, LEDs used to illuminate the camera subject and scare away threats, a microprocessor to analyze data from the sensors and interface with the system, and a wireless communication module for uploading data to the cloud and described herein. Module 40 is connected to Module 30 and Module 40 over copper wires.

Referring to FIG. 2, the catalytic converter 10 has input pipe 11 and output pipe 12. In this specific embodiment pictured in FIG. 2, only one catalytic converter is depicted, though a similar embodiment with other configurations of multiple catalytic converters can easily be reasoned. Module 20 contains the vibration sensors used to detect theft events produced by reciprocating saws and similar tools used remove a catalytic converter.

Referring to FIG. 3, Module 20 is shown in a different location, “post-cat”, on the exhaust pipe, to show that it can also be placed in a configuration on the output pipe of the catalytic converter.

Referring to FIG. 4, a front view of Module 20 is shown, consisting of numerous parts. 21 depicts a heat-resistant band, made of perforated stainless steel in one embodiment to which vibration sensors 22 and 23, and their wire connections 24 and 25, respectively, can be affixed. In this embodiment, only two sensors 22 and 23 are depicted, however, it is to be understood that in other embodiments both fewer (with a minimum of one) or more vibration sensors can exist in the configuration. The vibration sensors of Module 20 are of types spring-switch and ball tilt switch, connected to Module 40 via heat-resistant, oil-resistant, weatherproof, electrically insulated wires MI running along the vehicle chassis. The vibration spring-switch and ball switch sensors are normally open circuits that are closed when induced by different kinds of vibrations. In the case of a spring switch, the internal spring mounted system moves when the sensor is acted upon by external stimuli. The resultant movement within the switch results in a change in electrical voltage. This change in voltage is then measured by the microcontroller in Module 40. The ball tilt switch works similarly, except a small metal ball moves around within the switch when acted upon by external stimuli, thereby closing the circuit resulting in a change of measured electrical voltage. 26 shows a dotted line to a gray area that represents a high heat-resistant silicone-based substance in which the Module 20 is coated. This allows the device to be mounted on the input pipe 11 and/or output pipe 12, while also protecting the sensors and wires affixed to Module 20 from the heat of the pipes and the catalytic converter. This coating 26 is excluded from the area of and nearby 27, as this represents a component for adjusting the circumference of Module 20. In one embodiment, 27 features a worm drive device that can be adjusted by tightening, or loosening, the screw within the worm drive device, therein adjusting the circumference of the heat-resistant, stainless-steel band 21, therein securing the device 20 to the input pipe 11 and/or output pipe 12 of the catalytic converter. In another embodiment, 27 features a T-bolt clamp used to adjust the circumference of the heat-resistant, stainless-steel band 21. In another embodiment, 27 features a spring-loaded T bolt clamp to adjust the circumference of the band 21 and provide constant tension for the device 20 onto pipes 11 and/or 12. In yet another embodiment, 27 features a constant tension worm gear clamp to adjust the circumference of the band 21 and provide constant tension for the device 20 onto pipes 11 and/or 12.

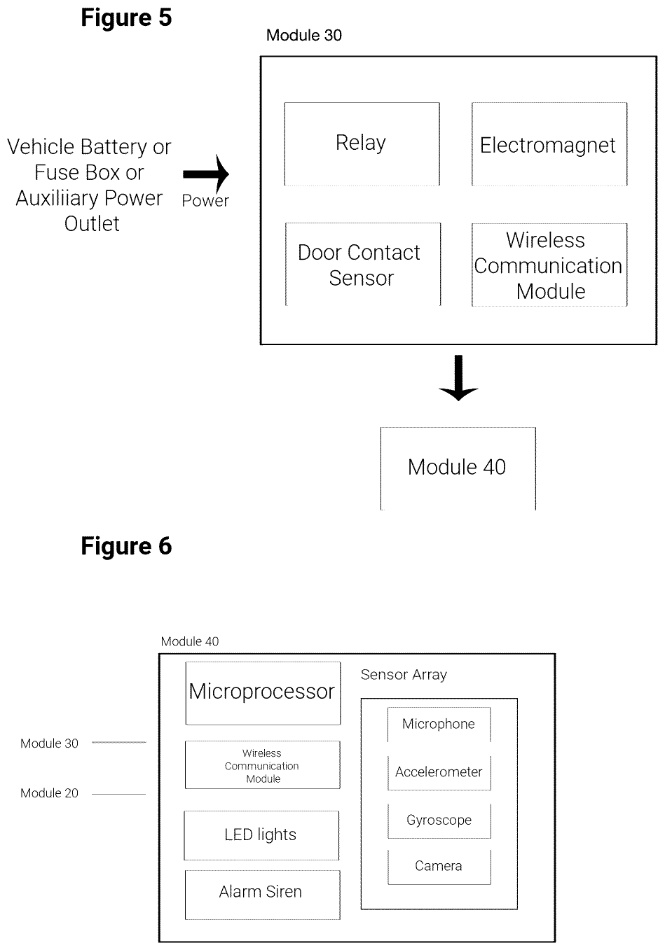

Referring to FIG. 5, depicted is a block diagram of Module 30. Module 30 draws power from the vehicle's fuse box, battery, or auxiliary power outlet. A multi-channel relay in module 30 is switched programmatically by the microcontroller in Module 40. The multi-channel relay controls power sent to the electromagnet in Module 30 and the LED lights used for scene illumination in Module 40. The block diagram in FIG. 5 depicts a reed switch door contact sensor that receives power from a battery or the aforementioned multi-channel relay. Further, the reed switch door contact sensor and electromagnet are located proximally, such that the magnetic field of the electromagnet can induce the contacts within the reed switch to magnetize and snap to each other thereby completing the circuit and inversely, open the circuit when the electromagnet is not producing a magnetic field thereby indicting a tamper event/intrusion, or system fault. The system allows door contact sensors from various manufacturer to be used, so long as the sensors contains a circuit that can be modulated by the presence of a magnetic field. The wireless communication module in Module 30 may enable wireless communication via, cellular-such as LTE, NFC, WiFi, Lora WAN, Bluetooth, GPS, and other communication pathways. Module 30 is connected to Module 40 via heat-resistant, oil-resistant, weatherproof, electrically insulated wires running along the vehicle chassis.

Referring to FIG. 6, Module 40 is an arrangement which contains a camera, microphone, accelerometer, gyroscope, LED lights for illumination, a microprocessor for analyzing the input signals and data from the aforementioned sensors, and a wireless communication module for sending data from the sensors to other networked devices and to the cloud. The camera in the arrangement captures an image with the catalytic converter in view and object detection software on the microcontroller classifies the objects present within the scene. Obstructions of the catalytic converter are classified as benign—as in the case of a ball rolling under a car, or an animal underneath the vehicle—to threatening, such as the presence of a person, an object identified as a saw, reciprocating saw, or other similar objects used in catalytic theft such as wrenches. Module 40 captures images at a regular interval for analysis to detect threats in real-time; the LED lights flash in low-light scenarios for scene illumination and improved object detection in low-light settings. The imaging sensor, Module 40, can interface directly with the microcontroller over communication protocols including, but not limited to, UART, SPI, I2C, PWM, and the image sensor can capture images on the visible-light spectrum and infrared spectrum, depending on the implementation. Further, the LED lights are programmed to flash in a threat-positive event to deter intruders. The omnidirectional microphone in the arrangement captures segments of 3-7 seconds of sound which is then analyzed by audio classification software on the microcontroller to capture the sound of threat events e.g. sawing sounds. This, when combined with the aforementioned object detection data can be used to further enhance the accurate classification of intrusion events. The accelerometer and gyroscope in the arrangement detect motion to provide additional data used in detecting intrusion events.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed. Various modifications and variations can be made without departing from the spirit or scope of the invention as set forth in the following claims both literally and in equivalents recognized in law.

This theft prevention system improves prior art via the ability to be easily secured on the chassis of a vehicle nearby a catalytic converter with no structural changes to the vehicle, a constantly improving detection system that “learns” to better distinguish between threatening vs non-threatening data gathered from the array of sensors over time (leading to fewer false alarms), and integration with a prior existing alarm system of a nearby premised owned by the vehicle's owner. This system supports vehicles with two catalytic converters and premises with multiple alarm systems.

1. A sensor system for a security system for monitoring theft-positive events of catalytic converters, comprising:
at least one sensor for detecting threatening vibrations, wherein sawing on the pipe near a catalytic converter produces the vibrations;
a sensor for detecting threatening sounds, wherein sawing on the pipe and/or power tools nearby the catalytic converter produces the sounds;
an imaging sensor for detecting suspicious activity images underneath the vehicle, wherein the images have in view the catalytic converter(s);
a motion sensor for detecting suspicious movements and orientation of the vehicle, wherein the system could be tampered with and/or the vehicle could be lifted at an angle in preparation for a theft event; and
a microcontroller for analyzing the signals from the various sensors to determine threat-positive events, controlling the relay for powering module components, and interfacing with the wireless communication modules.

2. The sensor system as in claim 1, wherein said sensor is a vibration sensor.

3. The sensor system as in claim 1, wherein said sound sensor is omnidirectional.

4. The sensor system as in claim 1, wherein said imaging sensor is a camera.

5. The sensor system as in claim 1, wherein said motion sensor is an accelerometer and/or gyroscope.

6. The sensor system as in claim 1, wherein said microcontroller is included in an enclosure with at least one of said sensor.

7. A method for securing a catalytic converter, said method comprising:
powering a low-voltage sensor security system using auxiliary power, vehicle battery, or fusebox;
analyzing signals and data from various sensors to detect threat-positive events with high probability;
running algorithms and data analysis on a microcontroller located within the security system to detect threat-positive events; and
interfacing a microcontroller with the wireless sensor of an alarm system of a premise, to programmatically generate an alarm.

8. The method as in claim 7, wherein the microcontroller stores algorithms, in memory, capable of interpreting multiple types of sensor data for classifying threat-positive events.

9. The method as in claim 7, wherein the power system provides constant power to the security system and sensors mentioned in the invention described herein.

10. The method as in claim 7, wherein said alarm is generated wirelessly and connection from the wireless sensor to the alarm system is over radio frequency, Wi-Fi, and other means of wireless communication.

11. The method as in claim 10, wherein the wireless sensor a premise's alarm system is a door contact sensor.

12. The method as in claim 7, wherein said various sensors contain a vibration sensor of type spring-switch and/or ball-tilt switch and is to be mounted and secured semi-permanently to input and/or output pipes to a catalytic converter.

13. The method as in claim 7, wherein said various sensors contain an omnidirectional sound sensor which outputs digital and/or analog values representing captured sound to be processed by the microcontroller.

14. The method as in claim 7, wherein said various sensors contain an imaging sensor capable of full-spectrum and infrared imaging.

15. The method as in claim 14, wherein animals and inanimate objects are classified as benign events whereas humans, saws, wrenches, and powered tools are classified as threat events.

16. The method as in claim 14, wherein the image sensor can interface directly with the microcontroller over communication protocols including, but not limited to, UART, SPI, I2C, PWM, and the images are captured can be infrared or no-infrared.

17. The method as in claim 7, wherein said various sensors contain a motion sensor comprised of an accelerometer and/or gyroscope.

19. A security system for securing a catalytic converter, comprising:
a plurality of sensors, including but not limited to audio sensors, image sensors, vibration sensors, and motion sensors, strategically placed on, or nearby, the catalytic converter of which capture signals and data to send as input to a microcontroller;
a microcontroller which controls power to the sensors, reads the signals and data output from the sensors to algorithmically determine a positive threat and/or theft, and interfaces with a wireless alarm sensor of a premise's alarm system;
an alarm system interfacing method of using a microcontroller, which algorithmically decides if sensor input data indicates an intrusion and then modulates a wireless alarm sensor, to trigger an alarm, wherein the wireless alarm sensor is described herein as a door contact sensor, and
a wireless communication module to provide the capability of sending signals and data from the invention described herein to other networked devices and to the cloud.
